(19) United States
(12) Patent Application Publication
(10) Pub. No.: US 2020/0084142 A1
(43) Pub. Date: Mar. 12, 2020

(54) PREDICTIVE ROUTING IN MULTI-NETWORK SCENARIOS

(71) Applicant: CA, Inc., New York, NY (US)

(72) Inventor: Sai Kumar Bochkar, Nizamabad (IN)

(21) Appl. No.: 16/128,836

(22) Filed: Sep. 12, 2018

(51) Int. Cl. H04L 12/723; H04L 12/721; H04L 12/803

(52) U.S. Cl. CPC H04L 45/50; H04L 47/125; H04L 45/70

(57) ABSTRACT

A method of accessing a multiprotocol label switching (MPLS) network includes routing data traffic from a network device to the MPLS network via a primary access network that connects the network device to the MPLS network, measuring a plurality of parameters of the primary access network, predicting a future change in at least one of the parameters of the primary access network based on measurements of the plurality of parameters of the primary access network, and routing data traffic to the MPLS network through a secondary access network that connects the network device to the MPLS network based on the prediction of the future change in the at least one of the parameters of the primary access network.

### BACKGROUND

The present disclosure relates to computer networks, and in particular to the routing of connections through computer communication networks.

### SUMMARY

Some embodiments provide a method of accessing a multiprotocol label switching (MPLS) network that includes routing data traffic from a network device to the MPLS network via a primary access network that connects the network device to the MPLS network, measuring a plurality of parameters of the primary access network, predicting a future change in at least one of the parameters of the primary access network based on measurements of the plurality of parameters of the primary access network, and routing data traffic to the MPLS network through a secondary access network that connects the network device to the MPLS network based on the prediction of the future change in the at least one of the parameters of the primary access network.

The method may further include measuring a plurality of parameters of the secondary access network. Switching the connection to the secondary access network may be performed based on a current measurement of the plurality of parameters of the secondary access network.

The method may further include measuring a plurality of parameters of the secondary access network and predicting a future change in at least one of the parameters of the secondary access network based on measurements of the plurality of parameters of the secondary access network. Switching the connection to the secondary access network may be performed based on the prediction of the future change in the at least one of the parameters of the primary access network and the future change in the at least one of the parameters of the secondary access network.

The method may further include balancing a communication load from the network device to the MPLS network between the primary access network and the secondary access network based on the prediction of the future change in the at least one of the parameters of the primary access network.

Predicting the future change in at least one of the parameters of the primary access network based on measurements of the plurality of parameters of the primary access network may include processing the plurality of parameters of the primary access network in real time via a neural network.

The method may further include training the neural network with actual network data from the primary access network to predict changes in the at least one of the parameters of the primary access network based on the plurality of parameters of the primary access network.

The parameters of the primary access network may include an available bandwidth, a quality of service (QoS) policy, a protocol used, a latency, a jitter, a throughput and an availability of network links of the primary access network.

The at least one of parameters of the primary access network may include a throughput of the primary access network.

The method may further include predicting the change in the at least one of the parameters of the primary access network based on a bandwidth requirement of a service that uses the connection.

The method may further include maintaining a label switched path in the MPLS network while the connection is switched from the primary access network to the secondary access network.

The primary access network and the secondary access network may connect the network device to a same label edge router in the MPLS network.

A method of accessing a network according to further embodiments includes routing data traffic through a primary access network, measuring a plurality of parameters of the primary access network, predicting a future network status of the primary access network based on measurements of the plurality of parameters of the primary access network, and routing the data traffic through a secondary access network based on the prediction of the future network status of the primary access network.

The method may further include generating an updated prediction of the network status of the primary access network following routing of the data traffic through the secondary access network and routing additional data traffic through the secondary access network in response to the updated prediction of the network status of the primary access network.

Other methods, devices, and computers according to embodiments of the present disclosure will be or become apparent to one with skill in the art upon review of the following drawings and detailed description. It is intended that all such methods, mobile devices, and computers be included within this description, be within the scope of the present inventive subject matter and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram illustrating a network environment in which embodiments according to the inventive concepts can be implemented.

FIG. 2 is a block diagram of a network status prediction system according to some embodiments of the inventive concepts.

FIG. 3 is a block diagram illustrating a neural network that may be used to implement the network status prediction system according to embodiments of the inventive concepts.

FIG. 4 is a block diagram of a computing system which can be configured as a distribution switch according to some embodiments of the inventive concepts.

FIGS. 5 and 6 are flowcharts illustrating operations of systems/methods in accordance with some embodiments of the inventive concepts.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

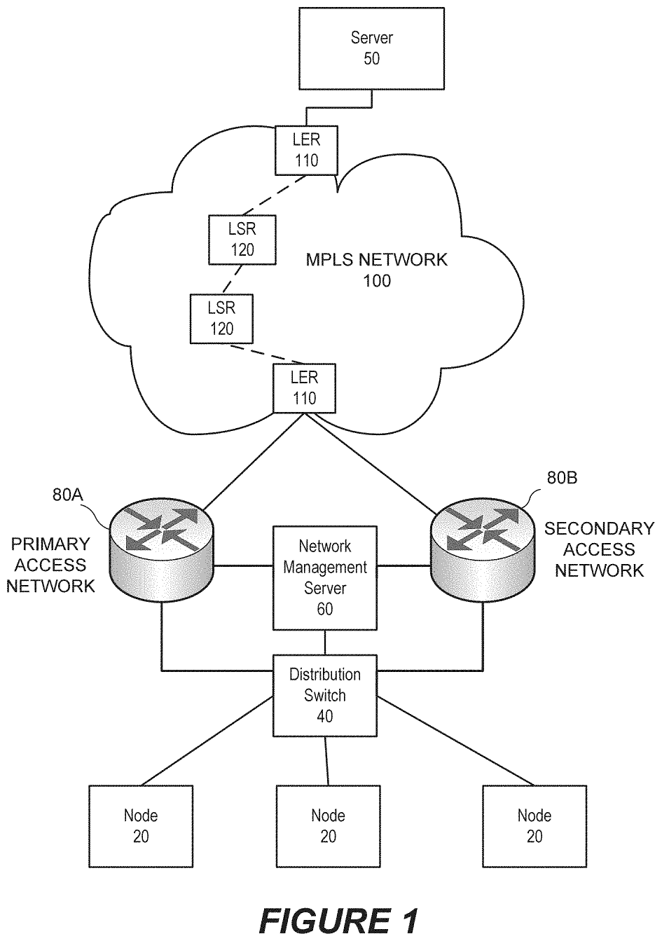

FIG. 1 is a block diagram of a network computing environment in which systems/methods according to embodiments of the inventive concepts may be employed. Referring to FIG. 1, a plurality of nodes 20 access a server 50 through a multi-protocol label switching (MPLS) network 100. MPLS is a type of data-carrying technique for high-performance telecommunications networks in which data from one network node is directed to the next node in a path based on short path labels rather than long network addresses, avoiding complex lookups in a routing table. The labels identify virtual links or paths between distant nodes rather than endpoints. MPLS can encapsulate packets of various network protocols, and supports a range of access technologies, including T1/E1, ATM, Frame Relay, DSL, etc.

As shown in FIG. 1, an MPLS network includes different types of internal switching points, including label edge routers (LERs) 110 at the edge of the network and label switched routers (LSRs) 120 within the network. LERs can be present within an MPLS network for additional encapsulation. A path through an MPLS network always begins and ends at a LER, however.

The nodes 20 may be physical network computing devices, such as servers that have processors and associated resources, such as memory, storage, communication interfaces, etc., or virtual machines that have virtual resources assigned by a virtual hypervisor. The nodes 20 access the MPLS network via one or more access networks 80A, 80B, which may include public data networks connected to the Internet and operated by different internet service providers. In addition, the nodes 20 may access the access networks via a distribution switch 40 which routes the connection from a node 20 to the server 50 to the appropriate access network 80A, 80B. Typically, one of the access networks 80A is a primary access network that is used by the distribution switch 40 to access the MPLS network 100. The other access network 80B, referred to as a secondary access network, may only be accessed if the primary access network 80A becomes unavailable or if the condition of the primary access network 80A deteriorates to the point that traffic to/from the nodes 20 is adversely affected. The distribution switch 40 may monitor one or more performance metrics associated with communications on the primary access network, such as throughput, latency, load, link quality, jitter, quality of service, etc., as it handles data traffic to/from the primary access network 80A, and determine an overall condition of the primary access network 80A based on such performance metrics.

The primary access network 80A and the secondary access network 80B may connect to the same LER 110 in the MPLS network 100. A network management server 60 may monitor various performance parameters of the primary access network 80A and the secondary access network 80B and provide information regarding the status of the primary access network 80A and the secondary access network 80B to the distribution switch 40.

Accordingly, in previous systems, it is known to monitor changes in the condition of an access network and react to detected changes that negatively impact data communication traffic by switching to a secondary access network, i.e., by re-routing traffic to/from the MPLS network 100 through a different access network 80A, 80B. Some embodiments described herein predict future changes in the condition of a primary access network 80A and re-route traffic from a distribution switch 40 through a secondary access network 80B before conditions on the primary access network 80A deteriorate to the point that traffic through the distribution switch 40 is substantially affected. That is, a prediction is made based on observing one or more parameters of the primary access network 80A that a future condition of the primary access network 80A will degrade to a point that traffic through the network is negatively affected, and change the routing of packets to travel through a secondary access network 80B responsive to the prediction of future behavior of the primary access network 80A. The prediction may take other factors into account, such as expected traffic load through the distribution switch 40, the number of clients 20 accessing the MPLS network 100, the type of traffic expected to be present in the future, etc.

Some embodiments may enable MPLS-bound traffic to be re-routed through a secondary access network 80B without any noticeable difference to the client devices, thereby providing a seamless user experience without network disconnections or interruptions. To facilitate this, it is desirable that the primary access network 80A and the secondary access network 80B connect to the same LER 110 at the entry to the MPLS network 100.

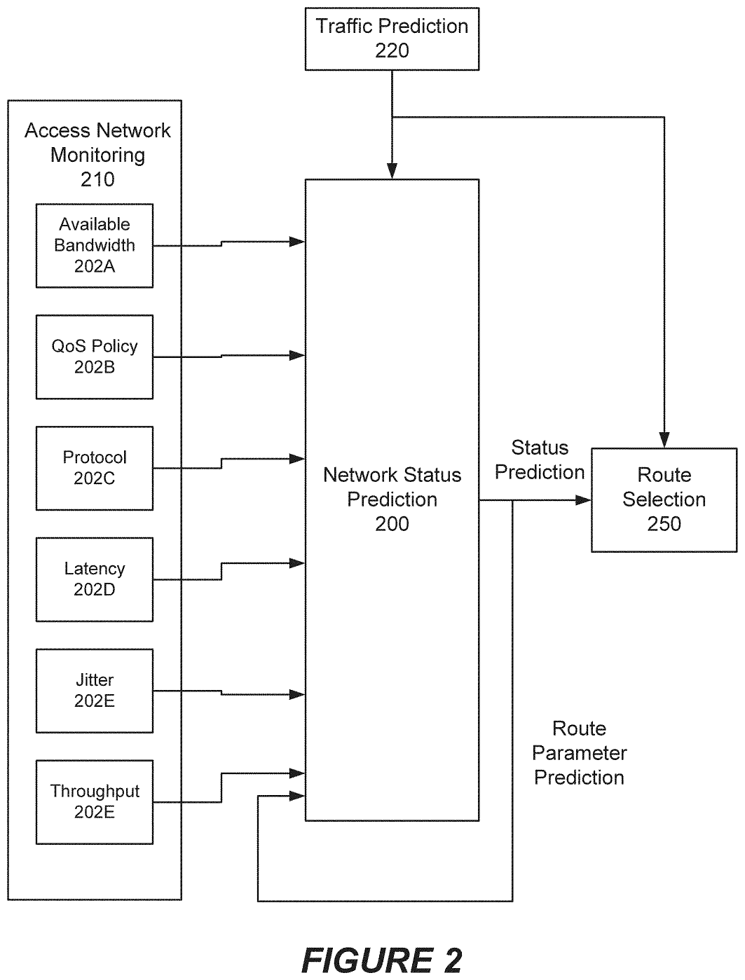

Referring to FIG. 2, according to some embodiments, the future state of a communication network may be predicted by a network status prediction model implemented by a network status prediction system 200. The network status prediction system 200 may be implemented within the distribution switch 40 or within a separate network device, such as a network management server 60 (FIG. 1).

The network state prediction system 200 may receive inputs from an access network monitoring system 210 that monitors one or more performance parameters of the primary access network 80A, such as available bandwidth 202A, a QoS policy 202B of the primary access network 80A, a communication protocol 202C employed by the primary access network 80A, a latency 202D of the primary access network 80A, a jitter 202E of the primary access network 80A and/or a measure of throughput 202E of the primary access network 80A. These and other performance parameters of the primary access network 80A are provided to a network status prediction system 200, which processes the performance parameters and responsively generates a predicted future state of the primary access network 80A. The access network monitoring system 210 may be implemented within the distribution switch 40 or within a separate network device, such as a network management server 60.

The prediction of the future state of the primary access network is provided to a route selection system 250 which may proactively cause the distribution switch 40 to switch the routing of packet data traffic from the primary access network 80A to the secondary access network 80B, for example, before any changes in the primary access network 80A cause connections from the distribution switch 40 to the MPLS network 100 to degrade.

The network status prediction system 200 may receive and use other information in the prediction of future performance of the primary access network 80A, such as predicted traffic through the distribution switch 40, which may be provided by a traffic prediction system 220. The traffic prediction system 220 may predict future utilization of the MPLS network 100 by devices served by the distribution switch 40 based on, for example, the timing, type and/or amount of scheduled data packet flows or previous data packet flows through the distribution switch 40 towards the MPLS network 100, or based on analysis of packets in a transmit buffer at the distribution switch 40.

The network status prediction system 200 may also use previous network status predictions as feedback input to the system to be used to refine the prediction of future network status based on comparison of actual performance parameters with predicted performance parameters.

The status prediction generated by the network status prediction system 200 may include a vector of one or more performance parameters of the primary access network 80A that the route selection system 250 may take into account in deciding whether to select a new route, such as predicted throughput, latency and/or bandwidth of data traffic in the primary access network 80A.

The route selection system 250 receives the status prediction of the future status of the primary access network 80A and determines whether the distribution switch 40 should route packet data traffic through a different access network based on the predicted status of the primary access network 80A. The route selection system 250 may also receive the traffic prediction information from the traffic prediction system 220 regarding predicted data traffic through the distribution switch 40 towards the MPLS network 100, and may use such information when deciding whether or not to route data traffic through a different access network. For example, the network status prediction system 200 may predict based on the current performance parameters of the primary access network 80A that at a future time T, the latency in the primary access network 80A will rise to 150% of a current latency value. Furthermore, the traffic prediction system 220 may predict that at the future time T, nodes 20 served by the distribution switch 40 will require, based on the type of traffic predicted to be received from the nodes, at least the current level of latency. In that case, the route selection system 250 may proactively cause the distribution switch 40 to route data packets to the secondary access network 80B before latency in the primary access network 80A rises.

In another example, the network status prediction system 200 may predict based on the current performance parameters of the primary access network 80A that at a future time T, the throughput of the primary access network 80A will fall to 50% of a current throughput value. Furthermore, the traffic prediction system 220 may predict that at the future time T, nodes 20 served by the distribution switch 40 will require, based on the type of traffic predicted to be received from the nodes, a level of throughput higher than the predicted level of throughput. In that case, the route selection system 250 may proactively cause the distribution switch 40 to route data packets to the secondary access network 80B before the throughput of the primary access network 80A degrades to a point that would require re-routing.

The route selection system 250 may cause the distribution switch 40 to route some or all packet data through the secondary access network 80B instead of the primary access network 80A. In particular, the route selection system 250 may enable the distribution switch 40 to perform load balancing between the primary access network 80A and the secondary access network 80B. Continuing the previous example, the route selection system 250 may cause the distribution switch 40 to route incremental levels of packet data traffic through the secondary access network 80B until the status prediction for the primary access network 80A output by the network status prediction system 200 indicates that at time T, the primary access network 80A will be predicted to provide at least a target latency performance. At that point, the route selection system 250 may cease to cause the distribution switch 40 to route more data packets through the secondary access network 80B.

In some embodiments, the access network monitoring system 210 may monitor both the primary access network 80A and the secondary access network 80B and provide performance data for both networks to the network status prediction system 200. The network status prediction system 200 may, in turn, generate network status predictions for both the primary access network 80A and the secondary access network 80B and provide such status predictions to the route selection system 250. The route selection system 250 may take into account the predicted status of both the primary access network 80A and the secondary access network 80B when making a decision as to whether to cause the distribution switch 40 to route traffic to the secondary access network 80B instead of the primary access network 80A.

In some embodiments, the network state prediction system 200 may be implemented using an artificial neural network. An artificial neural network is a computing system having a structure that is inspired by biological neural networks. Such systems may “learn” how to process input data by considering a priori known examples of input vectors and automatically adapting the network to produce the same results. An artificial neural network is based on a collection of connected units or nodes which act as artificial neurons and are connected by a mesh of connectors which simulate synapses. Each connection between nodes can transmit a signal from one node to another. The artificial neuron that receives the signal can process it and then signal artificial neurons connected to it.

In a typical artificial neural network implementation, the signal at a connection between nodes is a real number, and the output of each node is calculated by a non-linear function of the sum of its inputs. Such a function is referred to herein as a “combinational function” because it combines the outputs of other nodes. Nodes and/or connections typically have a weight that adjusts as learning proceeds. The weight increases or decreases the strength of the signal at a connection. The nodes may have a threshold such that a signal is sent only if the aggregate signal exceeds that threshold. Typically, nodes are organized in layers, where different layers may perform different kinds of transformations on their inputs. Signals travel from the first (input) layer of nodes, to the last (output) layer of nodes. “Learning” or training of artificial neural networks is typically performed by a process of backpropagation in which known outcomes are propagated back through the network, and the weights are adjusted according to a gradient function so that the system produces the known outcome in response to a particular input state, where an “input state” is the vector of input parameter values. Backpropagation can be considered a supervised training technique, because it uses a known output state for each input state that is trained.

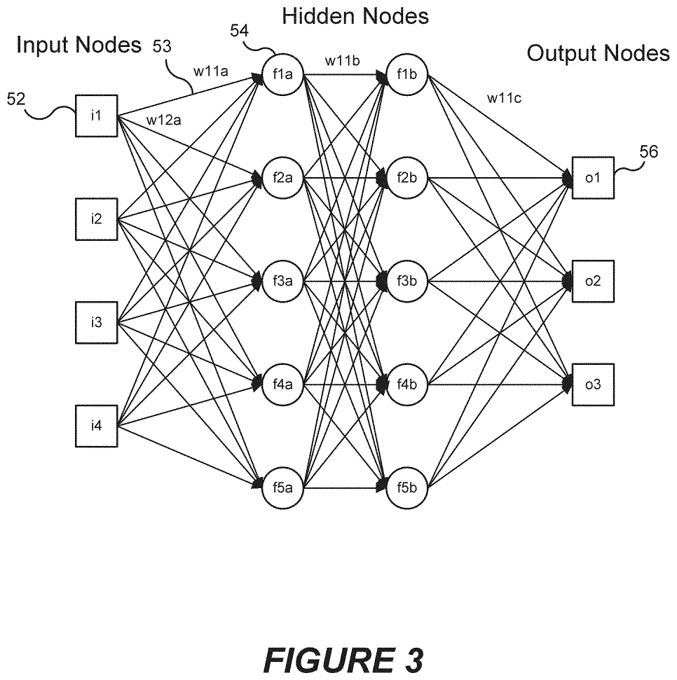

A simplified example of an artificial neural network is shown in FIG. 3. Referring to FIG. 3, an artificial neural network includes a plurality of input nodes 52 corresponding to a vector of input parameters, a plurality of hidden nodes 54 coupled to the plurality of input nodes 52 by means of a plurality of connectors 53, and a plurality of output nodes 56 coupled to the plurality of hidden nodes 54, each of the plurality of hidden nodes having an associated combinational function and each of the connectors having an associated weight. Although two levels of hidden nodes are shown in FIG. 3, more levels of hidden nodes may be provided. Moreover, more or fewer input nodes and/or output nodes may be provided than are shown in FIG. 3. At least some of the plurality of output nodes are associated with a predicted future status of the primary access network. For example, one of the output nodes may indicate a level of latency in the primary access network, one of the output nodes may indicate a level of throughput in the primary access network, one of the output nodes may indicate a level of buffer occupancy in the primary access network, etc.

The inputs may correspond to one or more measured properties of the primary access network, the network environment, the number of client devices accessing the primary access network and/or the types of communication traffic being carried, or predicted to be carried, by the primary access network. Each of the inputs is assigned a numerical value at the corresponding input node. A weight is applied to each input parameter when it is propagated to a node at the next level of the model. For example, a weight w11a is applied to the parameter at input node i1 before it is applied to the node f1a. Likewise, a weight w12a is applied to the parameter at input node i1 before it is applied to the node f2a. At each node, the weighted inputs received at that node are processed by a combinational function, such as f1a, f2a, etc., and the output of the node is subsequently weighted applied to nodes in the next level. At the output node, the outputs of the hidden nodes are optionally weighted again and combined to provide outputs.

Accordingly, in the systems/methods described herein, the input nodes 52 may correspond to the performance parameters of the primary and/or secondary access networks 8A, 80B provided by the access network monitoring system 210, and the output nodes 56 may correspond to the network status prediction information output by the network status prediction system 200 to the route selection system 250. The values of the weights w and combinational functions f used in the neural network that implements the network status prediction system 200 may be generated by means of supervised training as described above.

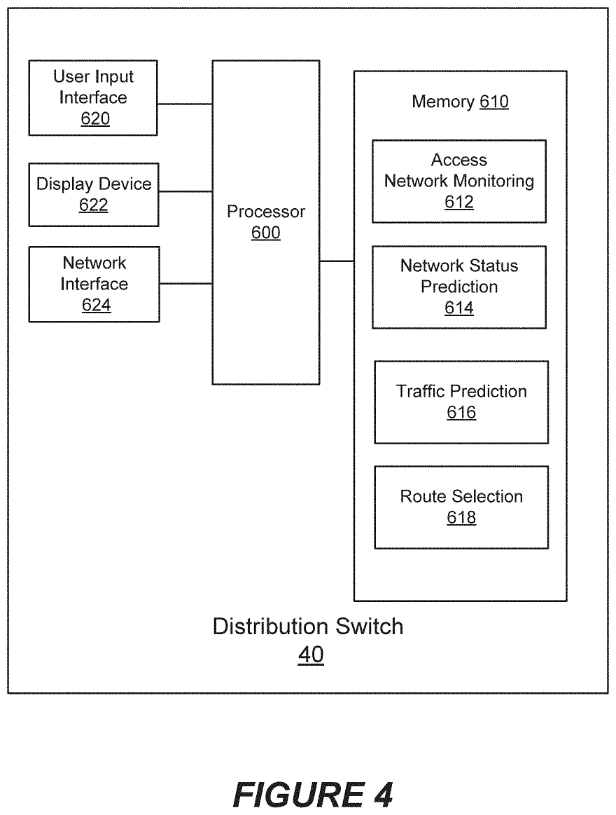

FIG. 4 is a block diagram of a distribution switch 40 that can be configured to perform operations according to some embodiments of the inventive concepts. The distribution switch 40 includes a processor 600, a memory 610, and a network interface 624, which may include a radio access transceiver and/or a wired network interface (e.g., Ethernet interface).

The processor 600 may include one or more data processing circuits, such as a general purpose and/or special purpose processor (e.g., microprocessor and/or digital signal processor) that may be collocated or distributed across one or more networks. The processor 600 is configured to execute computer program code in the memory 610, described below as a non-transitory computer readable medium, to perform at least some of the operations described herein. The distribution switch 40 may further include a user input interface 620 (e.g., touch screen, keyboard, keypad, etc.) and a display device 622.

The memory 810 includes computer readable code that configures the distribution switch 40 to implement the access network monitoring function of the access network monitoring system 210, the network status prediction function of the network status prediction system 200, the traffic prediction function of the traffic prediction system 220, and the route selection function of the route prediction system 250 shown in FIG. 2. In particular, the memory 810 includes access network monitoring code 612 that configures the distribution switch 40 to monitor one or more access networks, network status prediction code 614 that configures the distribution switch 40 to predict the network status of an access network at a future time, traffic prediction coder 616 that configures the distribution switch 40 to predict traffic that will be handled by the distribution switch 40 at the future time, and route selection code 618 that configures the distribution switch 40 to select a route for data traffic in response to the network status prediction.

It will be appreciated that one or more of the access network monitoring function of the access network monitoring system 210, the network status prediction function of the network status prediction system 200, the traffic prediction function of the traffic prediction system 220, and the route selection function of the route prediction system 250 shown in FIG. 2 may be implemented within the distribution switch 40 or in another computing device, such as a network management server 60. The network management server 60 may be configured in a similar manner as depicted in FIG. 4.

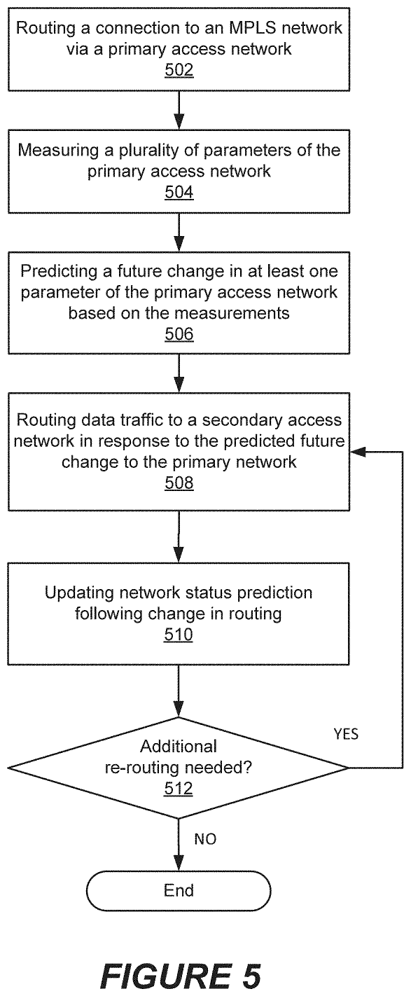

Operations of a distribution switch 40 according to some embodiments are illustrated in FIG. 5. As shown therein, a method of accessing a multiprotocol label switching (MPLS) network may include routing data traffic from a network device to the MPLS network via a primary access network that connects the network device to the MPLS network (block 502), measuring a plurality of parameters of the primary access network (block 504), predicting a future change in at least one of the parameters of the primary access network based on measurements of the plurality of parameters of the primary access network (block 506), and routing data traffic to the MPLS network to a secondary access network that connects the network device to the MPLS network based on the prediction of the future change in the at least one of the parameters of the primary access network (block 508).

In some embodiments, the systems/methods may also measure a plurality of parameters of the secondary access network and predict the future status of the secondary access network. The decision to route data traffic through the secondary access network may also be based on the prediction of the futures status of the secondary access network.

The systems/methods may then update the network status prediction of the primary and/or secondary access network following the routing of data traffic through the secondary access network (block 510), and then determine if additional re-routing is needed (block 512). For example, if the updated network status prediction indicates that the primary network will provide sufficient service after re-routing at least some data traffic through the secondary access network, then the operations may end. However, if the updated network status prediction indicates that the primary network will still be predicted to suffer performance degradation after re-routing data traffic through the secondary access network, then the operations may return to block 508, and the distribution switch may route additional data traffic through the secondary access network. The process may be repeated until either the predicted performance of the primary access network is at an acceptable level or all data traffic has been routed through the secondary access network.

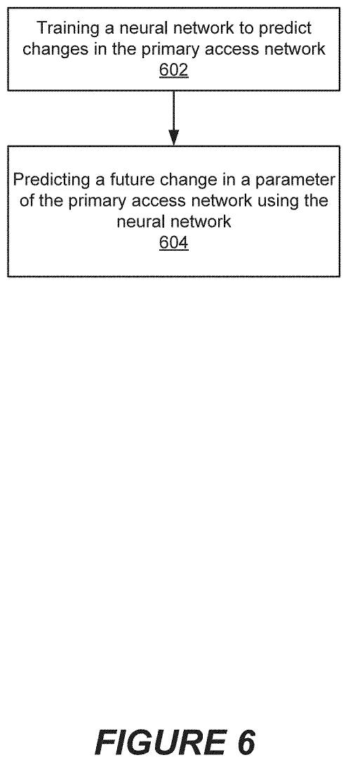

Operations of a distribution switch 40 according to some embodiments are illustrated in more detail in FIG. 6. As shown therein, some embodiments may include training a neural network to predict changes in the performance of an access network (block 602) and predicting a future change in at least one performance parameter of the access network using the neural network (block 604). As described above, training the neural network may include supervised training with backpropagation.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method of accessing a multiprotocol label switching (MPLS) network, comprising:
routing data traffic from a network node to the MPLS network through a primary access network that connects the network node to the MPLS network;
measuring a plurality of parameters of the primary access network;
predicting a future change in at least one of the parameters of the primary access network based on measurements of the plurality of parameters of the primary access network; and
routing the data traffic to the MPLS network through a secondary access network that connects the network node to the MPLS network based on the prediction of the future change in the at least one of the parameters of the primary access network.

2. The method of claim 1, further comprising:
measuring a plurality of parameters of the secondary access network;
wherein switching the connection to the secondary access network is performed based on a current measurement of the plurality of parameters of the secondary access network.

3. The method of claim 1, further comprising:
measuring a plurality of parameters of the secondary access network; and
predicting a future change in at least one of the parameters of the secondary access network based on measurements of the plurality of parameters of the secondary access network;
wherein switching the connection to the secondary access network is performed based on the prediction of the future change in the at least one of the parameters of the primary access network and the future change in the at least one of the parameters of the secondary access network.

4. The method of claim 1, further comprising:
balancing a communication load from the network node to the MPLS network between the primary access network and the secondary access network based on the prediction of the future change in the at least one of the parameters of the primary access network.

5. The method of claim 1, wherein predicting the future change in at least one of the parameters of the primary access network based on measurements of the plurality of parameters of the primary access network comprises processing the plurality of parameters of the primary access network via a neural network.

6. The method of claim 5, further comprising:
training the neural network with actual network data from the primary access network to predict changes in the at least one of the parameters of the primary access network based on the plurality of parameters of the primary access network.

7. The method of claim 1, wherein the parameters of the primary access network comprise an available bandwidth, a quality of service (QoS) policy, a protocol used, a latency, a jitter, a throughput and an availability of network links of the primary access network.

8. The method of claim 1, wherein the at least one of parameters of the primary access network comprises a throughput of the primary access network.

9. The method of claim 7, further comprising:
predicting the change in the at least one of the parameters of the primary access network based on a bandwidth requirement of a service that uses the connection.

10. The method of claim 1, further comprising maintaining a label switched path in the MPLS network while the connection is switched from the primary access network to the secondary access network.

11. The method of claim 1, wherein the primary access network and the secondary access network connect the network node to a same label edge router in the MPLS network.

12. A distribution switch comprising:
a processor; and
a memory coupled to the processor, the memory comprising non-transitory computer readable instructions that configure the processor to:
route data traffic from a network node to a multi-protocol label switching (MPLS) network through a primary access network that connects the network node to the MPLS network;
measure a plurality of parameters of the primary access network;
predict a future change in at least one of the parameters of the primary access network based on measurements of the plurality of parameters of the primary access network; and
route the data traffic to the MPLS network through a secondary access network that connects the network node to the MPLS network based on the prediction of the future change in the at least one of the parameters of the primary access network.

13. The distribution switch of claim 12, wherein the computer readable instructions further configure the processor to:
measure a plurality of parameters of the secondary access network;
wherein switching the connection to the secondary access network is performed based on a current measurement of the plurality of parameters of the secondary access network.

14. The distribution switch of claim 12, wherein the computer readable instructions further configure the processor to:
measure a plurality of parameters of the secondary access network; and
predict a future change in at least one of the parameters of the secondary access network based on measurements of the plurality of parameters of the secondary access network;
wherein switching the connection to the secondary access network is performed based on the prediction of the future change in the at least one of the parameters of the primary access network and the future change in the at least one of the parameters of the secondary access network.

15. The distribution switch of claim 12, wherein the computer readable instructions further configure the processor to:
balance a communication load from the network node to the MPLS network between the primary access network and the secondary access network based on the prediction of the future change in the at least one of the parameters of the primary access network.

16. The distribution switch of claim 12, wherein predicting the future change in at least one of the parameters of the primary access network based on measurements of the plurality of parameters of the primary access network comprises processing the plurality of parameters of the primary access network via a neural network.

17. The distribution switch of claim 12, wherein the computer readable instructions further configure the processor to:
maintain a label switched path in the MPLS network while the connection is switched from the primary access network to the secondary access network.

18. The distribution switch of claim 12, wherein the primary access network and the secondary access network connect the network node to a same label edge router in the MPLS network.

19. A method of accessing a data communication network, comprising:
routing data traffic to the data communication network through a primary access network;
measuring a plurality of parameters of the primary access network;
predicting a future network status of the primary access network based on measurements of the plurality of parameters of the primary access network;
routing the data traffic to the data communication network through a secondary access network based on the prediction of the future network status of the primary access network.

20. The method of claim 19, further comprising:
generating an updated prediction of the network status of the primary access network following routing of the data traffic to the data communication network through the secondary access network; and
routing additional data traffic to the data communication network through the secondary access network in response to the updated prediction of the network status of the primary access network.
